(19) United States
(12) Patent Application Publication
(10) Pub. No.: US 2017/0278119 A1
(43) Pub. Date: Sep. 28, 2017

(54) METHOD AND APPARATUS FOR CONTENT DISTRIBUTION IN ONLINE MARKETPLACE APPLICATIONS

(71) Applicant: eBay Inc., San Jose, CA (US)

(72) Inventor: Yoram Baruch VARDI, Sunnyvale, CA (US)

(73) Assignee: eBAY INC., San Jose, CA (US)

(21) Appl. No.: 14/611,102

(22) Filed: Jan. 30, 2015

(51) Int. Cl. G06Q 30/02

(52) U.S. Cl. CPC G06Q 30/0205

(57) ABSTRACT

A method and apparatus for facilitating access by users at remote locations to an online marketplace. In an embodiment, one or remote platforms are provided at remote locations. Data in a data warehouse at a central location in the marketplace may be analyzed for content expected to be of interest to the users at the remote locations. Such content may be stored at a remote platform for easier access by users who normally may access that remote platform. New content in the data warehouse may be analyzed periodically, so that new content may be stored at the remote platform.

### TECHNICAL FIELD

This application relates generally to the field of electronic commerce and, in particular, to a method and system for content distribution to facilitate online marketplace access from remote locations.

### BACKGROUND

Websites may have their load times shortened by having local servers store content so that users closer to the local servers can access content more quickly. However, where content is stored periodically and/or statically on the local servers, using for example a content delivery network, the content does not change sufficiently quickly to reflect the preferences of local users. As a result, those local users still have to access at least some content remotely. Those local users may experience longer load times and longer wait times for access to content. The longer load and wait times can discourage those local users from using the online marketplace.

### BRIEF DESCRIPTION OF THE DRAWINGS

The present disclosure is illustrated by way of example, and not by way of limitation, in the accompanying drawings in which:

FIG. 1 is a network diagram depicting a network system having a client-server architecture configured for exchanging data over a network, according to one embodiment.

FIG. 2 is a block diagram illustrating database content and various possible attributes according to an embodiment.

FIG. 3 is a block diagram illustrating a content analysis application according to an embodiment.

FIG. 4 is a block diagram illustrating operation of a content analysis application according to an embodiment.

FIG. 5A is a flow diagram illustrating operation of a content analysis application according to an embodiment.

FIG. 5B is a flow diagram illustrating operation of a content analysis application according to an embodiment.

FIG. 5C is a flow diagram illustrating operation of a content analysis application according to an embodiment.

FIG. 5D is a flow diagram illustrating operation of a content analysis application according to an embodiment.

FIG. 6 is a diagrammatic representation of a database, in the exemplary form of a storage server, within which a set of instructions may be executed, according to an embodiment.

### DETAILED DESCRIPTION

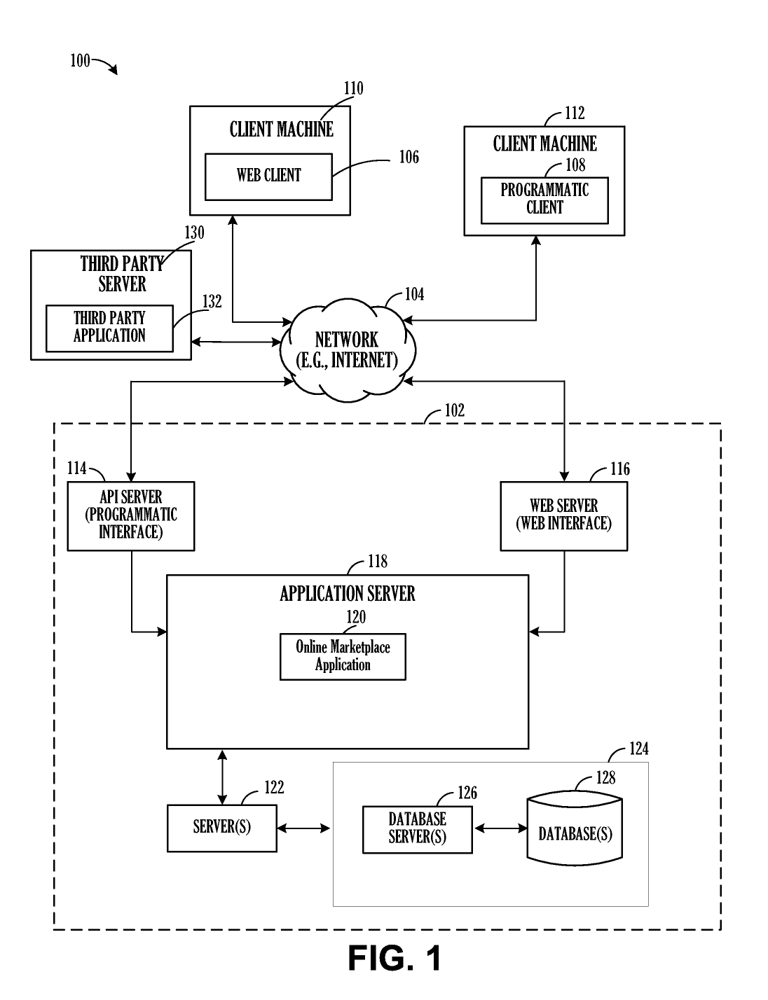

FIG. 1 is a diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and content tracking information) associated with the network system 100 and its users. Although FIG. 1 shows a client-server architecture, other embodiments may include other network architectures, such as peer-to-peer or distributed network environments.

By way of non-limiting example, a data exchange platform 102 may include an application server 118 that hosts marketplace application 120. Application server 118 communicates with data warehouse 124. One or more servers 122 may facilitate communication between application server 118 and data warehouse 124. Data warehouse 124 may include database server(s) 126 and database(s) 128. The platform 102 may provide server-side functionality via a network 104 (e.g., the Internet) to one or more clients 110, 112. Users may employ the one or more clients to access and utilize the marketplace application 120 over the network 104. Marketplace application 120 in turn may communicate with data warehouse 124 to fetch requested data. The data may include, but is not limited to, content and user data such as user profiles; user attributes; product and service information, such as pricing and descriptive information, including for example static content, such as pictures and/or videos, relating to listings; product and service listings associated with buyers and sellers; auction bids; and transaction data, such as collection and payment and shipping transactions, among others. Some of the above-listed exemplary information may be stored in database(s) 128, but more generally may be stored in the data warehouse 124.

In an embodiment, there are a plurality of data exchange platforms 102. One or more of these may be in a particular geographic location (home location). One or more other data exchange platforms 102 may be in respective geographic locations, remote from the home location (remote locations). The content of the data warehouse 124 may be different in each of the geographic locations. In an embodiment, the data warehouse 124 in the home location may contain all of the online marketplace data that an online marketplace may use. In an embodiment, the data warehouse 124 in the remote locations may contain a subset of that data. In this fashion, users in one of the remote locations may access the platform 102 at the home location, or may access the platform 102 in the remote location nearest the users. The farther the users are from the home location, the longer it can take the users to research, review, and conduct online marketplace transactions.

Content delivery networks can facilitate provision of data from the platform 102 at the home location to the platform(s) 102 at the remote location(s). Such provision is relatively static, and fails to take into account real-time preferences and platform usage of users at the remote location(s).

Looking a little more closely at user access to a platform 102, in an embodiment, data exchanges within the network system 100 may depend on user-selected functions available through one or more client or user interfaces (UIs). The UIs may be associated with a client machine, such as a client machine 110 using a web client 106. The web client 106 may communicate with online marketplace application 120 via a web server 116. The UIs may also be associated with a client machine 112 using a programmatic client 108, such as a client application, or a third party server 130 with a third party application 132. It can be appreciated that in various embodiments, the client machines 110 or 112 may be associated with a buyer, a seller, a third party electronic commerce platform, a payment service provider, a shipping service provider, or a financial institution system, each in communication with the data exchange platform 102 and optionally with each other. The buyers and sellers may be any one of individuals, merchants, or service providers.

Within platform 102, an application program interface (API) server 114 and a web server 116 are coupled to, and provide programmatic and web interfaces respectively to, one or more application servers 118. The application server 118 hosts one or more marketplace applications 120. The application server 118, in turn, may be coupled to data warehouse 124, including database server(s) 126 and database(s) 128 as described previously. Data warehouse 124 may contain content that is the subject of data exchanges that network system 100 facilitates. For example, a user may request content from marketplace application 120. The content may be data about a particular item or service listed on marketplace application 120. Marketplace application 120 in turn may fetch the requested content from data warehouse 124. Data warehouse 124 (and in an embodiment, database(s) 126) also may contain data regarding past data exchanges, for example, data concerning past purchases of items or services including the price, item or service type, and location of the purchaser, among others.

In an embodiment, the web server 116 and the API server 114 may communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130). The marketplace application 120 provides listings and price-setting mechanisms for users, who may be buyers who list, or sellers who buy, view, or search for goods and/or services published on the marketplace application 120.

A method for determining content to be stored on one or more of the remote servers may include analyzing content attributes, and updating content attributes based on information received from marketplace application 120 to determine what content is to be stored at the remote location(s). The content can be seller listings of items that are popular with users in the remote location(s). The content attributes may include, but are not limited to item description and listing data (in one embodiment, related to keywords/important keywords), number of requests for the content, number of searches for the content, number of times the content shows up in searches, and whether the item can be shipped to a particular buyer.

In an embodiment, the method analyzes postings of new content (seller side) in marketplace application 120. For example, if a seller posts a new item, the item may not have been available for a sufficient period of time for all attributes of the content (such as number of requests or searches for the content) to be relevant in determining whether the content should be stored at the remote location(s). Therefore, a content analytics application (discussed in more detail below) may analyze a subset of the attributes in order to determine whether content that is newly posted should be stored at the remote location(s). For example, users accessing a platform 102 a particular remote location may find particular items, categories of items, and/or items with particular attributes (e.g. color, size) to be particularly desirable. A content analytics application may take that desirability into account as part of the storing decision.

In an embodiment, the content analytics application also may use its analyzed data to make recommendations about content to users and to influence advertisements that users see based on the users' locale.

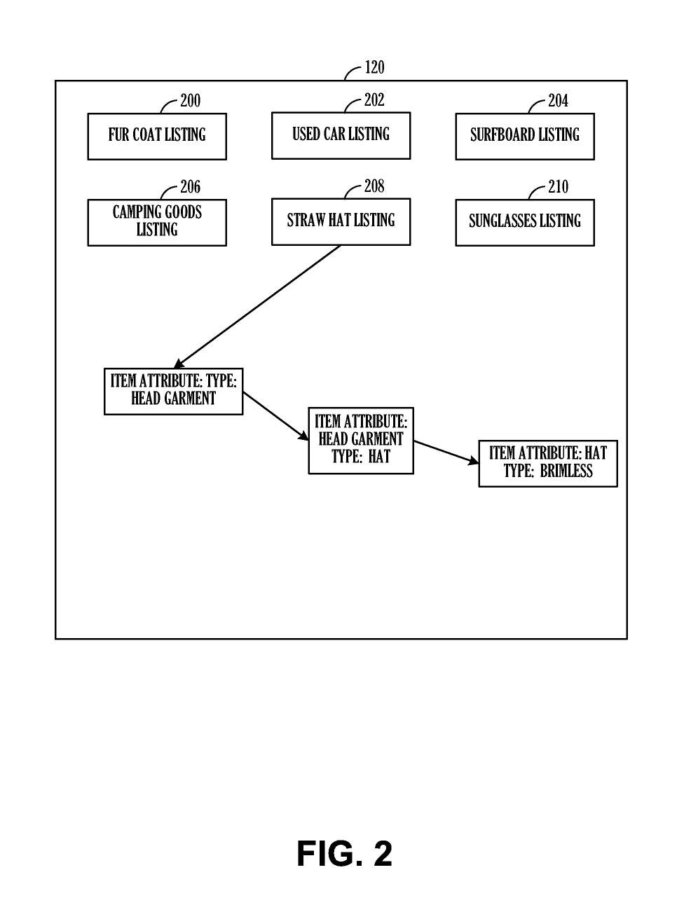

FIG. 2 shows an aspect of an online marketplace application 120 containing content related to listings in an online marketplace. By way of non-limiting example, FIG. 2 shows a fur coat listing 200, a used car listing 202, a surfboard listing 204, a camping goods listing 206, a straw hat listing 208, and a sunglasses listing 210. A listing may have one or more pictures and/or videos associated with it. In addition, each category of content may have a variety of attributes associated with it. One or more of those attributes may wind up in a listing. By way of example only, FIG. 2 shows some example attributes potentially associated with straw hat listing 208, including the type of garment (a head garment), the particular type of head garment (a hat, as contrasted with a cap), and a particular type of hat (a brimless hat, as contrasted with a brimmed hat).

Classification of attributes in this fashion may be useful, for example, in two different ways. First, if a content analytics application determines that a particular category of product, e.g. a brimless hat, is popular with users at a particular remote location, listings for brimless hats may be pushed to a data exchange platform 102 at that remote location, for users' ease of access there. Limiting the pushed content to brimless hats, rather than hats or head garments generally, can be more efficient. Second, if a new listing appears for a brimless hat, even if it is not a listing that users at a remote location have tried to access by search or by browsing (for example, because of the newness of the listing), identification of the relevant attribute at this level of detail (perhaps, in an embodiment, together with an indication of willingness of a seller to ship the product to the remote location) can prompt the listing to be pushed to the remote data exchange platform 102, without waiting for users to access the particular listing.

The pushing of content for storage at remote locations potentially falls into at least one of two categories. If one or more users at a remote location have accessed the content previously, the content would be stored at the remote location. If the content is pushed to a remote location because of anticipated user access at that location, the content may be referred to as being pre-cached. While every effort has been made to use the terms “storage” and “pre-caching” consistently with the just-described categories, usage of one of the terms with another of the categories is not intended to limit particular content to a particular presence on a data exchange platform 102 at the remote location. In an embodiment, because of differences in size between cache storage and other storage, content which might be pre-cached in some circumstances may be stored instead, to facilitate user access to the content at the remote location.

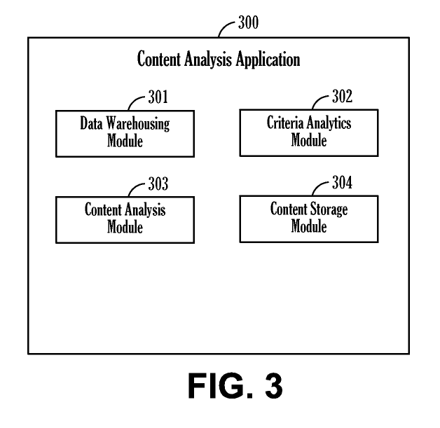

FIG. 3 shows aspects of an embodiment of a content analysis application 300. Content analysis application 300 may run in a data exchange platform 102 at a central location, or at a remote location, depending on how content for storage at the remote location is to be determined. The particular hardware on which the application 300 runs within platform 102 is not critical. Content analysis application 300 may include a data warehousing module 301, a criteria analytics module 302, a content analysis module 303, and a content storage module 304.

In an embodiment, data warehousing module 301 may track various attributes of content within the data warehouse 124. For example, data warehousing module 301 may track content attributes such as item type, item description (which may include item color and a picture or video of the item), item price, and/or brand associated with the item or the item description (and existence of certain keywords therein). Data warehousing module 301 may also track content popularity attributes, such as the number of times users from a given remote location have viewed an item, the number of times content has shown up in search results from queries from that location, and the number of times users at that location have searched for that content. In an embodiment, data warehousing module 301 may also track content seller attributes. These lists of attributes are intended to be illustrative only and are not exhaustive of the number or type of attributes that may be tracked by data warehousing module 301. Others will be apparent to ordinarily skilled artisans.

In an embodiment, data warehousing module 301 may monitor and log all content for changes in attributes which appear to appeal to users at a remote location. For example, if a user at a remote location requests particular content, data warehousing module 301 may update content popularity attributes corresponding to number of times particular content has shown up in search queries, number of times the content has been searched for, and the number of times the content was requested. In an embodiment, content may be considered to be requested if a user accesses the particular content (for example, by browsing a category or set of listings) or searches for the particular content, or if the particular content comes up in search results.

In an embodiment, data warehousing module 301 may also track data about a seller of the item. Such seller data may include: seller location, seller willingness to ship to the remote destination, shipping price, and the seller's rating (e.g. number of times the seller has sold something; feedback the seller may have received about any of the sales transactions (e.g. promptness in shipment, ease of dealing with the seller), and the like).

In an embodiment, data warehousing module 301 may also track content pertaining to past transactions. Content pertaining to past transactions may include attributes about items purchased, such as an item type, item color, item size, item price, item brand, item description and frequency of purchase of the item items determined to be similar. In an embodiment, criteria analytics module 302 may also analyze attributes about sellers or buyers of the items purchased such as the seller criteria mentioned above, and corresponding data about a buyer (e.g. number of purchases the buyer may have made, feedback the buyer may have received about any of the purchases (e.g. promptness in payment, ease of dealing with the buyer), and the like).

In an embodiment, criteria analytics module 302 analyzes data pertaining to past transactions for one or more remote locations. Criteria analytics module 302 may determine which content attributes may be most indicative of content likely to be searched and/or requested by a user at a particular remote location based on the data pertaining to past transactions. For example, criteria analytics module 302 may determine that particular clothing articles and particular clothing colors are popular content attributes in in a particular remote location, such as a particular country or region. The criteria analytics module 302 may make such determination(s) by reviewing analytics relating to searches and past transactions by users in that country or region. Criteria analytics module 302 may identify those attributes (e.g. clothing articles and colors) as likely to be terms in searches by users in that particular country or region or as factors indicating that particular content is likely to be requested by users in that particular country or region. In an embodiment, data for those items and perhaps related items, including identification of sellers of those and related items, may be transferred to database(s) in the platform 102 located in that country or region.

In an embodiment, criteria analytics module 302 may assign ranges of values to particular items such as, in the current discussion, clothing article and color. In an embodiment, the module 302 may use content attributes such as the ones just mentioned as indicative of content likely to be searched for and/or requested by a user from the particular country or region, to determine a threshold score for an item in a particular country or region. Subsequently, content attaining a score at or above the threshold score may be uploaded to the database(s) for the platform 102 located in that country or region.

In an embodiment, criteria analytics module 302 may distinguish between more relevant and less relevant attributes based on which attributes of items were most consistently indicative of content likely to be searched for and/or requested by a user from a given country or region.

In an embodiment, for a given country or region, criteria analytics module 302 may store the determined attributes and the threshold score.

In an embodiment, content analysis module 303 may analyze database content which may be representative of items listed in an online marketplace. In particular, content analysis module 303 may analyze various content attributes for those items and determine, for each item or category of items, a score for a given country or region based on the content attributes. Content analysis module 303 may determine the score for the given country or region by calculating a number of content attributes that match content attributes indicating that the particular content is likely to be requested by users in the particular country or region as determined by the criteria analytics module 302.

Ordinarily skilled artisans will appreciate that online marketplaces can have very large numbers of listings which come and go either as a particular item is sold, or as a seller decides to pull the item from the online marketplace. Consequently, item-by-item analysis as just described may be impractical in some contexts. Analysis of item attributes, as described above with respect to FIG. 2, may be more efficient and effective, particularly in the context of providing useful content to users at a remote location to facilitate searching of that content, even if no user at that location had accessed any of that content previously.

In an embodiment, content analysis module 303 may determine the score by considering content frequency attributes of content in the database as well. For example, content analysis module 303 may analyze the number of times an item or category of items (e.g. item attributes) has been viewed from a particular country or region, the number of times it has been searched from that particular country or region, and the number of times it has shown up in search results from that particular country or region as logged by data warehousing module 301. As the number of instances increases, content analysis module 303 may increase the item's score for that particular country or region.

In an embodiment, content analysis module 303 also may analyze data about a seller associated with the content. For example, if content analysis module 303 determines that the seller is willing to ship to the country or region, content analysis module 303 may increase the score for the content for that country or region.

In an embodiment, a seller may list a new item for sale in a marketplace application 120 on platform 102. The marketplace application 120 now will contain a listing for that item and the content corresponding to that item now will be located in data warehouse 124. Because the listing is new, there will not be any content frequency attributes for content analysis module 303 to analyze. Content analysis module 303 may therefore determine a score in a given country or region for newly posted content by comparing content attributes of the newly-listed item to popular content attributes for a given country or region. In an embodiment, content analysis module 303 may assign greater weight to certain content attributes when analyzing newly posted content to determine a score.

In an embodiment, content analysis module 303 may compare the determined score(s) for particular content to the corresponding threshold score(s) by country or region. If the content's score for a country or region is at or above the threshold score for that country or region, content analysis module 303 may identify that item for storage at remote platform 102 in that country or region. If an item's score for a particular location does not meet or exceed the corresponding threshold score for that country or region, then the item's content will not be stored at that remote platform 102, and content analysis module 303 will wait until there has been a change in circumstances that could result in a change to the score of the item (as, for example, because of additional remote user access to the item, or additional remote user access to other items having appropriate attributes sufficiently similar to those of the item) before analyzing that particular content again. For example, a user from that country or region may search for a particular category of item. The particular content may show up in the search results. The user may then view the content. This activity may result in an increase in relative prominence of certain attributes for the item, and may prompt data warehousing module 301 to signal content analysis module 303 to perform an analysis on the item again, to see whether the item's attributes sufficiently match those of attributes of content already stored at the remote location. Looking for a sufficient match may involve a recomputation of the previously determined score for the item.

In an embodiment, content analysis module 303 may require a sufficient change in relevant aspects of the item before analyzing that item again. Alternatively, any time there is sufficient activity from the remote location, resulting in access to content at the central platform, content analysis module may undertake the analysis again. The amount of change required may vary depending on the score initially determined for that item.

In an embodiment, remote user access to content bearing on items at the central location may motivate analysis not only of those items, but also of items having similar attributes which remote users may not be accessing (but which an attribute analysis would indicate would be relevant to the remote users). In such circumstances as well, content analysis module 303 may be instructed to visit or revisit the prior analysis.

Although the embodiments herein may be described with respect to a particular country or region, one of ordinary skill in the art will appreciate that they may be implemented with respect to one or more remote locations, and that the description herein is for illustrative purposes only.

Although the foregoing discussion describes obtaining a threshold score for content in order to determine if the content should be stored in a remote location, such storage may be determined without obtaining the threshold score first. In an embodiment, content analysis module 303 may effectuate transfer of content for storage at a remote location based on identification of certain content attributes without determining a score for the content. For example, content analysis module 303 may determine that the attributes of certain content correspond sufficiently to content that was previously flagged for storage at a particular country or region. In that event, the content may be stored at that location.

In an embodiment, content analysis module 303 may assign a weight to each attribute based on the attribute's importance as determined by the criteria analytics module 302.

In an embodiment, content storage module 304 aggregates all content flagged for uploading based on the country or region where the content is to be stored.

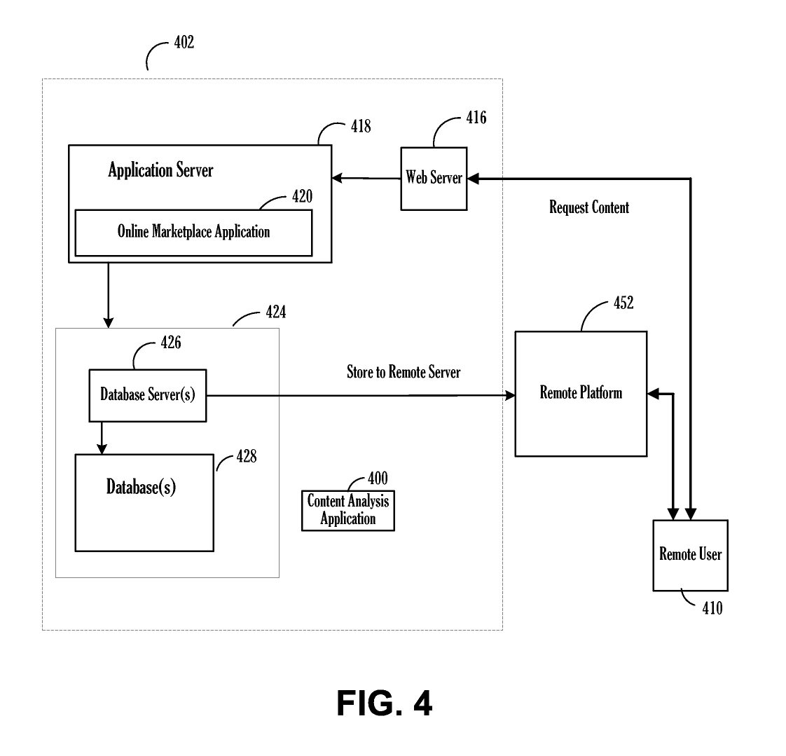

Referring to FIG. 4, data exchange platform 402 may have hardware similar to, and may be configured similarly to data exchange platform 102 in FIG. 1. In an embodiment, data warehouse 424 in data exchange platform 402 in a central location may store content that is potentially to be stored to a platform in remote location. The content may include items or services which are listed in an online marketplace.

Content analysis application 400 is stored in, and runs on platform 402. As mentioned earlier with respect to content analysis application 300 in FIG. 3, the precise hardware on which content analysis application 400 runs is not critical. Content analysis application 400 may determine what content stored within data warehouse 424 should be stored to a remote data exchange platform 452 for access by a remote user 410. In an embodiment, remote data exchange platform 452 may have hardware similar to, and may be configured similarly to data exchange platform 402. If the content is to be stored on platform 452, database server(s) 426 may upload the content to be stored to remote platform 452.

Referring again to FIG. 4, in an embodiment, a remote user 410 may request content from an online marketplace application 420 in data exchange platform 402. The remote user 410 may make the request via a web server 416 that communicates with an application server 418. The application server 418 may host the marketplace application 420, and may communicate the request for content to data warehouse 424. The data warehouse 424 receives the request for content and fetches the content, at least some of which may, in an embodiment, be stored in database(s) 428. In turn, content analysis application 400 registers the request and updates the attributes of the fetched content associated with item popularity. For example, upon registering a request for particular content, content analysis application 400 may update the “number of requests” attribute associated with that content. Content analysis application 400 also may register other attributes, such as content category or sub-category, and may determine whether the content should be stored to remote data exchange platform 452 based on the registered attributes.

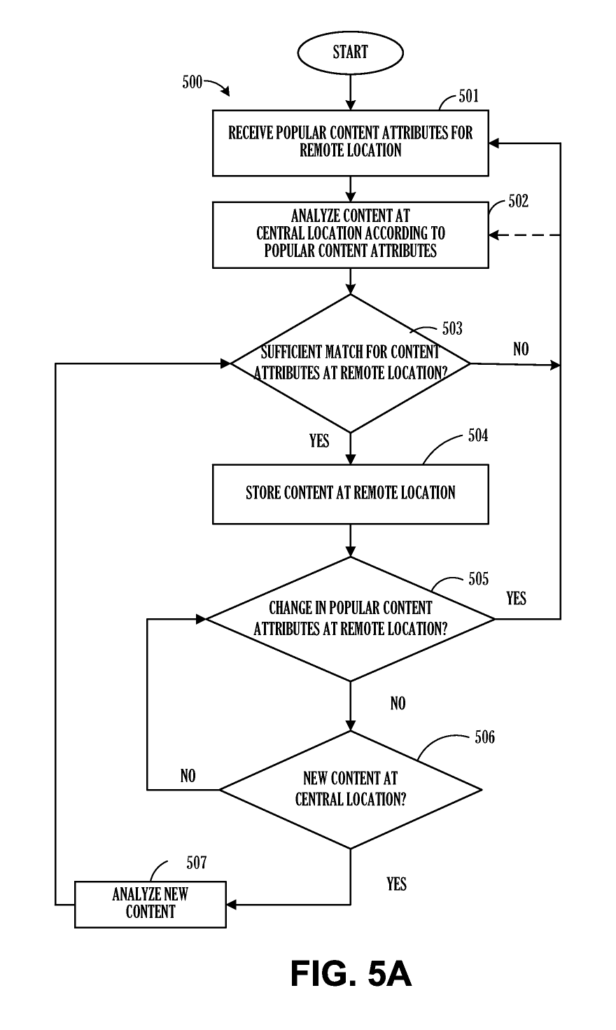

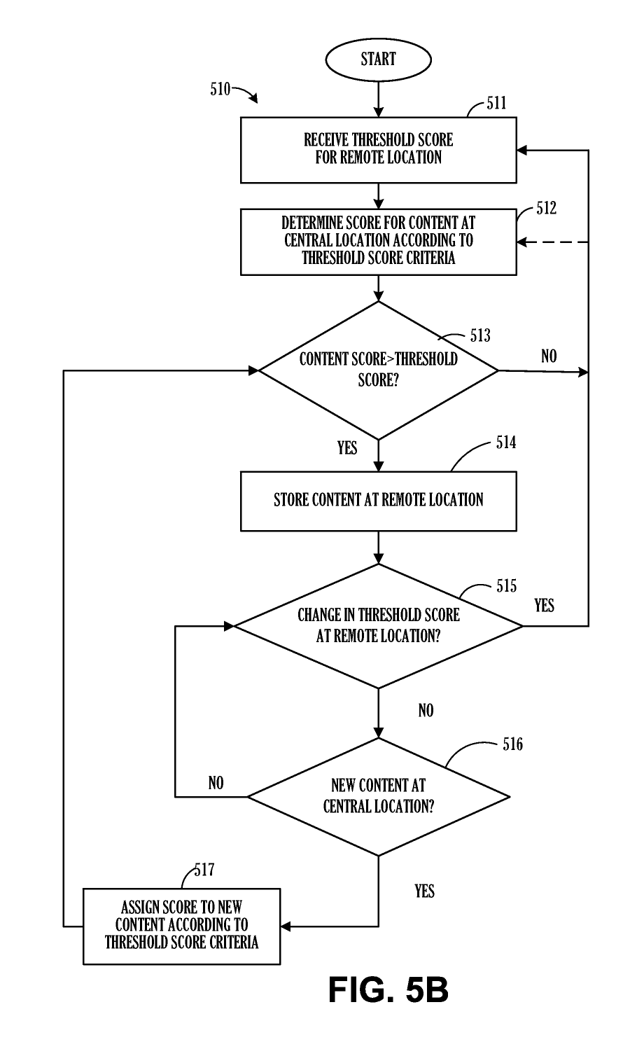

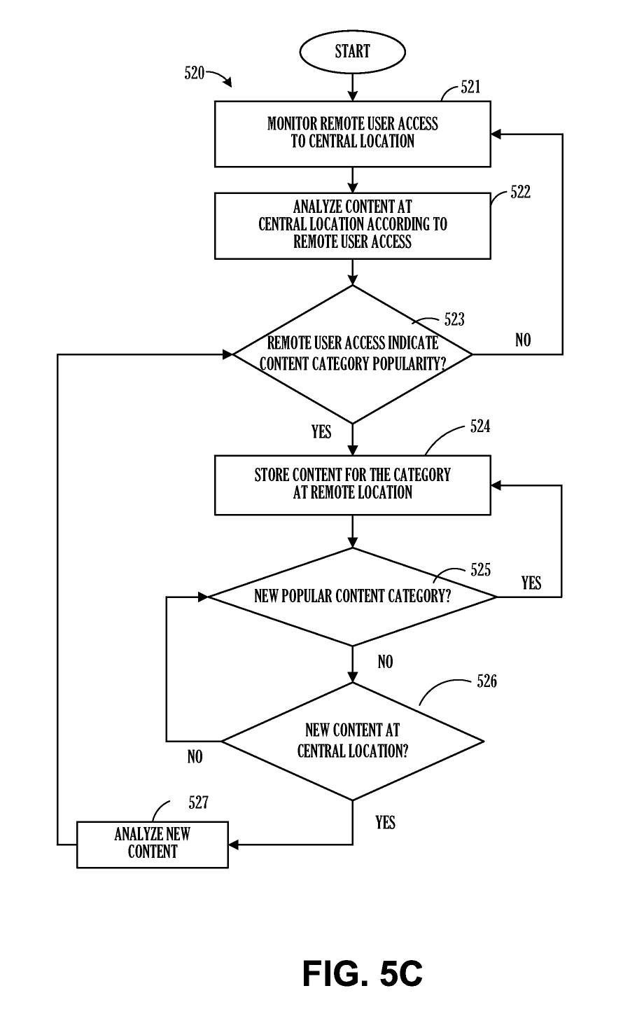

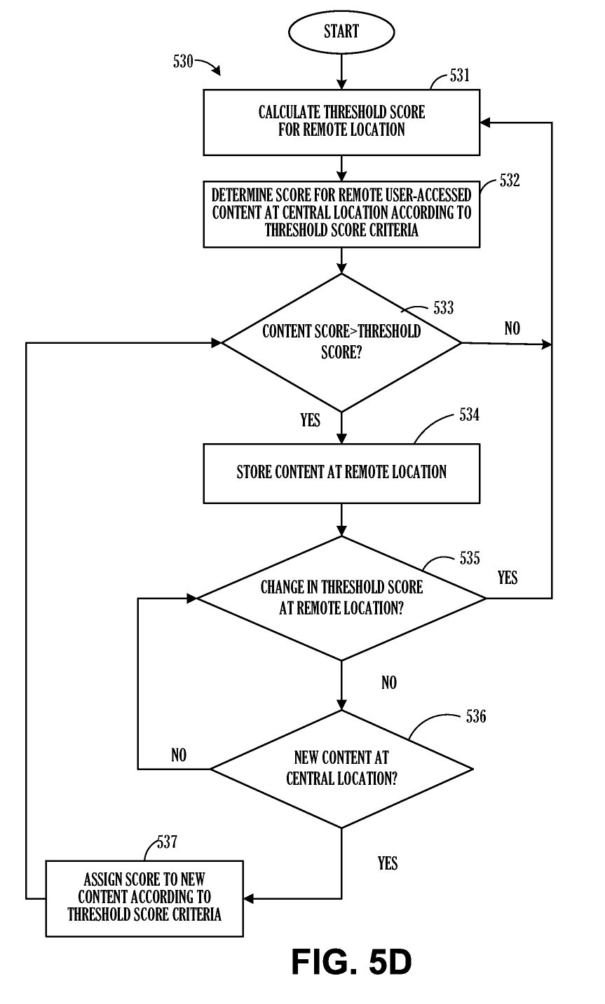

FIG. 5A illustrates a flow diagram of one embodiment. At 501, popular content attributes at a remote location, based on a variety of factors (examples being past sales, past searches, and/or past browsing) are determined. Popularity may be determined in various ways. For purposes of FIG. 5A, popularity may derive from criteria such as a number of transactions within a given period of time; a number of transactions after some predetermined time; a known sudden surge in interest in a particular good or category of goods; and the like. For purposes of this discussion, a “transaction” need not be a consummated sale. Rather, a “transaction” could be any expression of interest by a user at the remote location, from a search, to a viewing of particular items, to remote user communication with one or more sellers about items in a category, to an actual purchase.

Attributes may pertain to particular goods, or they may span categories of goods (e.g. color, pattern, logo).

In an embodiment, there may be certain categories of goods, not necessarily having popular content attributes, which an online merchant nevertheless wishes to make available at that remote location, to facilitate transactions in those goods at that remote location. Content relating to those goods still might be analyzed from the standpoint of popular content attributes at the remote location, but storage of the content at the remote location will not depend on how the attributes of that content match up with the popular content attributes.

At 502, content at the central platform is analyzed according to these attributes. At 503, a determination is made as to whether the attributes any of the content at the central location sufficiently matches the popular content attributes. If not, flow may return to 501, for new or further receipt of popular content attributes. Alternatively, flow may return to 502, for further analysis of central platform content (in case, for example, there is new content, although new content also is accounted for later in the flow diagram, as will be discussed).

If there is a sufficient match between the popular content attributes and the central platform content attributes, then at 504 any content with a sufficient match is stored at the remote location. After that, changes in popular content attributes at the remote location are monitored (505). For example, various types of user activity may signal changing interests of users at the remote location. If there is a change, those changes are received (flow reverting to 501).

If there is no change, presence of new content at the central location is monitored (506). Of course, in an online marketplace, listings come and go all the time. To avoid what otherwise could be constant churning, then, some periodicity for analysis could be set, or perhaps a time of day (e.g. during a time of relative inactivity at the remote location). Other analysis criteria can include the indicated duration of a new listing. For example, a listing that is indicated for posting for more than a particular length of time might be a suitable candidate for movement to the platform at the remote location. Flow would revert to 503 to undertake that analysis of new content.

It should be noted that, while for example 505 and 506 indicate a monitoring of change and a reversion of flow based on updates, it also may be appropriate periodically to restart the process, and begin afresh at 501. For example, it may be appropriate to remove expired listings and the like from the platform at the remote location. As another example, criteria for determining popular content attributes may change, for instance, based on changing trends in fashion, in music, or in another category of goods.

FIG. 5B illustrates a flow diagram of one embodiment. At 511, a threshold score for content popularity at a remote location, based on a variety of factors (examples being past sales, past searches, and/or past browsing) is determined. Popularity may be determined in various ways. For purposes of FIG. 5B, popularity may derive from criteria such as a number of transactions within a given period of time; a number of transactions after some predetermined time; a known sudden surge in interest in a particular good or category of goods; and the like. For purposes of this discussion, a “transaction” need not be a consummated sale. Rather, a “transaction” could be any expression of interest by a user at the remote location, from a search, to a viewing of particular items, to communication with one or more sellers about items in a category, to an actual purchase.

A threshold score may be applied to a good, to a category of goods, to attributes of certain goods, or to attributes which span categories of goods (e.g. color, pattern, logo). Central location content having a score above the threshold score may be stored at the remote location.

In an embodiment, there may be certain categories of goods, not necessarily having popular content attributes, which an online merchant nevertheless wishes to make available at that remote location, to facilitate transactions in those goods at that remote location. Content relating to those goods still might have scores determined based on popularity at the remote location, but storage of the content at the remote location will not depend on the score.

At 512, a score for content at the central platform is determined according to criteria related to popularity of goods or categories of goods. At 513, a determination is made as to whether the determined score at the central platform is greater than the threshold score. If not, flow may return to 511, for new or further receipt of threshold scores, or changed threshold scores. Alternatively, flow may return to 512, for further analysis of central location content (in case, for example, there is new content, although new content also is accounted for later in the flow diagram, as will be discussed).

If the score for central platform content is greater than the threshold score, then at 514 any such content will be stored at the remote location. After that, changes in threshold scores, or in manner of compiling threshold scores at the remote location are monitored (515). For example, various types of user activity may signal changing interests of users at the remote location, and therefore a need to alter how threshold scores are computed. If there is a change, those changes are received (flow reverting to 511).

If there is no change, presence of new content at the central platform is monitored (516). Of course, in an online marketplace, listings come and go all the time. To avoid what otherwise could be constant churning, then, some periodicity for analysis could be set, or perhaps a time of day (e.g. during a time of relative inactivity at the remote location). Other analysis criteria can include the indicated duration of a new listing. For example, a listing that is indicated for posting for more than a particular length of time might be a suitable candidate for movement to the platform at the remote location. If there is new content (517), flow would revert to 513 to undertake that analysis of new content, to see if the new content has a score higher than the threshold score.

It should be noted that, while for example 515 and 516 indicate a monitoring of change and a reversion of flow based on updates, it also may be appropriate periodically to restart the process, and begin afresh at 511. For example, it may be appropriate to remove expired listings and the like from the platform at the remote location. As another example, criteria for determining popularity may change, for instance, based on changing trends in fashion, in music, or in another category of goods.

FIG. 5C illustrates a flow diagram of one embodiment. At 521, remote user access to the central platform is monitored. In an embodiment, some types of remote user access may be more relevant than others. For purposes of determining what central platform content should be transferred to the remote location, remote user access to central platform content could be monitored to identify specific goods, one or more categories of goods, or one or more common characteristics of goods. For example, if a sports team in a country does well, residents may be interested in goods bearing the team's logo, and so may search for goods with that logo, whether they are clothing, glassware, furniture, or something else. Content concerning goods bearing a country's team logo may be stored at the remote location already, but for example in an Olympic year, a country's team that wins a medal might yield a lot of searches for Olympic logo-bearing goods, and so content pertaining to those goods, otherwise residing on the central platform only, might be transferred to the remote platform.

As another example, a particular movie may become very popular in the remote location, and so remote users may search content pertaining to that movie. Such content should be transferred to the remote platform in accordance with an embodiment.

The foregoing examples are instances of analyzing central platform content according to remote user access (522). Popularity may be determined in various ways, as discussed previously.

At 523, if remote user access indicates popularity of a particular good, category of goods, or category of content pertaining perhaps to multiple categories of goods (e.g. logos, per an earlier example), corresponding content will be stored at the remote location (524). If popularity is not indicated, flow can return to 521, where monitoring of remote user activity at the central platform may continue.

At 525, if for some reason, perhaps unrelated to actual remote user access, indicates a new content category that is popular, content for that category may be stored at the remote platform. In an embodiment, there may be certain categories of goods which are not necessarily popular at the time, but which an online merchant nevertheless wishes to make available at that remote platform, to facilitate transactions in those goods at that remote platform. Content relating to those goods still might have scores determined based on popularity at the remote location, but storage of the content at the remote platform will not depend on the score.

If there is no new popular content category, presence of new content at the central location is monitored (526). If there is new content, it will be analyzed to see whether any of the new content is popular, based on remote user access (527). Of course, in an online marketplace, listings come and go all the time. To avoid what otherwise could be constant churning, then, some periodicity for analysis could be set, or perhaps a time of day (e.g. during a time of relative inactivity at the remote platform). Other analysis criteria can include the indicated duration of a new listing. For example, a listing that is indicated for posting for more than a particular length of time might be a suitable candidate for movement to the platform at the remote location. Flow would revert to 523 to undertake that analysis of new content, to see if the new content indeed is popular.

FIG. 5D illustrates a flow diagram of one embodiment. At 531, a threshold score for content popularity at a remote location, based on a variety of factors (examples being past sales, past searches, and/or past browsing) is determined. Popularity may be determined in various ways, as discussed previously.

A threshold score may be applied to a good, to a category of goods, to attributes of certain goods, or to attributes which span categories of goods (e.g. color, pattern, logo). Central location content having a score above the threshold score may be stored at the remote location.

In an embodiment, there may be certain categories of goods, not necessarily having popular content attributes, which an online merchant nevertheless wishes to make available at that remote location, to facilitate transactions in those goods at that remote location. Content relating to those goods still might have scores determined based on popularity at the remote location, but storage of the content at the remote location will not depend on the score.

At 532, a score is determined for remote user-accessed content at the central platform according to criteria related to popularity of goods or categories of goods. At 533, a determination is made as to whether the score for that content is greater than the threshold score. If not, flow may return to 531, for new or further receipt of threshold scores, or changed threshold scores.

If the score for remote user-accessed central platform content is greater than the threshold score, then at 534 any such content will be stored at the remote location. After that, changes in threshold scores, or in manner of compiling threshold scores at the remote location are monitored (535). For example, various types of user activity may signal changing interests of users at the remote location, and therefore a need to alter how threshold scores are computed. If there is a change, those changes are received (flow reverting to 531).

If there is no change, presence of new content at the central platform is monitored (536). Of course, in an online marketplace, listings come and go all the time. To avoid what otherwise could be constant churning, then, some periodicity for analysis could be set, or perhaps a time of day (e.g. during a time of relative inactivity at the remote location). Other analysis criteria can include the indicated duration of a new listing. For example, a listing that is indicated for posting for more than a particular length of time might be a suitable candidate for movement to the platform at the remote location. If there is new content (537), flow would revert to 533 to undertake that analysis of new content, to see if the new content has a score higher than the threshold score.

In the foregoing embodiments, movement of potentially relevant new data from the central data warehouse to remote platforms has been described. As listings end, data related to those listings may be removed from the remote platforms, either by communication from the central platform, or by a facility at the remote platform that monitors expiration of listings.

In the foregoing description, values of attributes and/or scores for items have been described by way of values being assigned, and/or scores being determined. It should be noted that these values and scores need not be fixed, but instead may be calculated according to algorithms which respond to updated data from remote platforms and automatically update these values and scores.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of the exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. In some embodiments, he modules referred to herein may be processor-implemented.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

Embodiments may be implemented in digital electronic circuitry, or in computer hardware, firmware, software, or in combinations thereof. Embodiments may be implemented using a non-transitory computer-readable storage medium, (e.g., a computer program tangibly embodied in an information carrier, e.g., in a non-transitory machine-readable medium for execution by, or to control the operation of, data processing apparatus, e.g., a programmable processor, a computer, or multiple computers).

A computer program can be written in any form of programming language, including compiled or interpreted languages, and can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 104 as in FIG. 1.

In embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network such as network 104. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Hardware (e.g., machine) and software architectures that may be deployed in various embodiments now will be described.

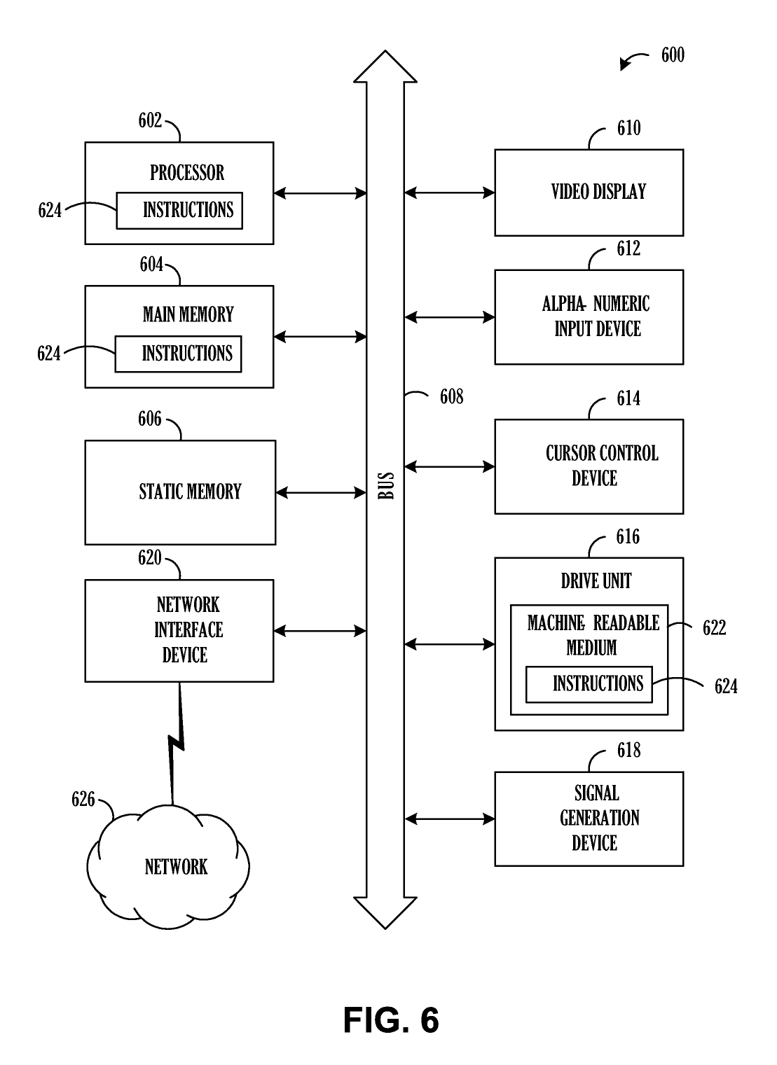

FIG. 6 is a diagrammatic representation of an exemplary computer system 600, within which a set of instructions may be executed to cause the machine to perform any one or more of the methodologies discussed herein. The computer system 600, in whole or in part, may be embodied in any of the servers or other machines shown in FIG. 1.

In some embodiments, the machine operates as a standalone device, or may be connected (e.g., networked) to other machines. In a networked deployment, the machine may operate as a server or a client machine 110 or 112 in a client-server network environment, or as a peer machine in a peer-to-peer (or distributed) network environment. The machine may be a personal computer (PC), a tablet, a set-top box (STB), a personal digital assistant (PDA), a smartphone, a web appliance, a network router, switch or bridge, or any machine capable of executing a set of instructions 624 (sequential or otherwise) that specify actions to be taken by that machine. Further, while only a single machine is illustrated, the term “machine” shall also be taken to include any collection of machines that individually or jointly execute a set (or multiple sets) of instructions 624 to perform any one or more of the methodologies discussed herein.

In an embodiment, the computer system 600 may include a processor 602 (e.g., a central processing unit (CPU), a graphics processing unit (GPU, or both)), a main memory 604 and a static memory 606, which communicate with each other via a bus 608. The computer system 600 may further include a video display unit 610 (e.g., a liquid crystal display (LCD), a plasma display, a light-emitting diode (LED) display, or a cathode ray tube (CRT) display). The computer system 600 also may include an alphanumeric input device 612 (e.g., a keyboard or keypad), a UI navigation device 614 (e.g., a mouse or touchpad), a disk drive or other storage (e.g. solid-state device, or SSD) unit 616, a signal generation device 618 (e.g., a speaker), and a network interface device 620.

The disk drive unit 616 may include a machine-readable medium 622 on which is stored one or more sets of instructions and data structures (e.g., software 624) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media 622.

The instructions 624 may further be transmitted or received over a network 626 (which is not part of the computer system 600) via the network interface device 620, utilizing any one of a number of well-known transfer protocols (e.g., HTTP).

While the machine-readable medium 622 is shown in an embodiment to be a single medium, the term “machine-readable medium” should be taken to include a single medium or multiple media (e.g., a centralized or distributed database, and/or associated caches and servers) that store the one or more sets of instructions 624. The term “machine-readable medium” shall also be taken to include any medium that is capable of storing, encoding, or carrying a set of instructions 624 for execution by the machine and that cause the machine to perform any one or more of the methodologies of the present disclosure, or that is capable of storing, encoding or carrying data structures utilized by or associated with such a set of instructions 624. The term “machine-readable medium” shall, accordingly, be taken to include, but not be limited to, solid-state memories, optical media, and magnetic media.

As alluded to earlier, particular sequences of operations in various embodiments are provided for convenience, and are not intended to imply that the same order is required in all embodiments. Any operational sequence in which a subsequent operation does not depend on a previous one is appropriately within the scope of this disclosure.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that, in some cases, various features may be grouped together to streamline the disclosure. This method of disclosure is not to be interpreted as reflecting an intention that the claimed embodiments require more features than are expressly recited in each claim. Rather, the following claims reflect subject matter including fewer than all features of a single disclosed embodiment. Thus, the following claims are hereby incorporated into the Detailed Description, with each claim standing on its own as a separate embodiment.

Although the present disclosure has been described with reference to certain embodiments, it will be evident that various modifications and changes may be made to these embodiments without departing from the broader spirit and scope of the disclosure. Accordingly, the specification and drawings are to be regarded in an illustrative rather than a restrictive sense.

1. A method comprising:
tracking one or more content attributes of goods listed on an online marketplace, the one or more content attributes of a respective good including one or more content attributes selected from a group of content attributes consisting of: an item type of the respective good, an item description of the respective good, an item price of the respective good, and a brand of the respective good;
monitoring remote user transactions on the online marketplace with respect to the goods in which the remote user transactions are performed on user devices located in a region that corresponds to a remote marketplace platform of the online marketplace that is remote from a central marketplace platform of the online marketplace;
determining, based on the monitoring, one or more popularity attributes for the remote marketplace platform with respect to the goods, the one or more popularity attributes of a respective good including one or more popularity attributes selected from a group of popularity attributes consisting of: a number of times a listing of the respective good has been viewed, a number of times the listing of the respective good has been included in search results, a number of times a content attribute of the respective good has been searched or viewed, and a number of times the content attribute or another content attribute of the respective good has been included in search results;
determining a set of popular content attributes for the remote marketplace platform, the set of popular content attributes including one or more of the tracked content attributes determined to be of interest in the region based on the one or more popularity attributes and the goods and content attributes that correspond to the one or more popularity attributes;
analyzing content related to goods listed on the online marketplace and that is stored at the central marketplace platform;
identifying, as matching content and based on the analyzing of the content, which of the content stored at the central marketplace platform has attributes that sufficiently match one or more content attributes included in the set of popular content attributes;
sending, based on the matching content having attributes that sufficiently match the one or more popular content attributes, the matching content from the central marketplace platform to the remote marketplace platform for storage at the remote marketplace platform; and
in response to receiving a user request related to the matching content and that originated from a user device located in the region, retrieving, for access by the user device, the matching content from the remote marketplace platform instead of the central marketplace platform to reduce a load time of the matching content on the user device.

2. A method as claimed in claim 1, further comprising:
analyzing new content at the central marketplace platform using the popular content attributes, the new content being received at the central marketplace platform after sending the matching content to remote marketplace platform;
identifying, as matching new content and based on the analyzing of the new content, which of the new content stored at the central marketplace platform has attributes that sufficiently match one or more popular content attributes included in the set of popular content attributes;
sending, based on the matching new content having attributes that sufficiently match the one or more popular content attributes, the matching new content from the central marketplace platform to the remote marketplace platform for storage at the remote marketplace platform; and
in response to receiving a user request related to the matching new content and that originated from the user device located in the region, retrieving the matching new content from the remote marketplace platform instead of the central marketplace platform to reduce a load time of the matching new content on the user device.

3. A method as claimed in claim 1, further comprising:
updating the set of popular content attributes in response to changes to the goods listed on the online marketplace and in response to an update to the one or more popularity attributes; and
identifying the matching content based on the updated set of popular content attributes.

4. A method as claimed in claim 1, further comprising determining a threshold score for one or more of the popular content attributes, wherein:
the analyzing comprises determining a content score for the content at the central marketplace platform using the popular content attributes; and
identifying the matching content comprises comparing the threshold score with the content score in which content having a score higher than the threshold score is identified as the matching content.

5. A method as claimed in claim 1, wherein the user transactions comprise one or more transactions selected from a group of transactions consisting of: searching content for goods of potential interest to the user; reviewing results of the content searches; making inquiries to one or more sellers of the goods; bidding on one or more of the goods; and purchasing one or more of the goods.

6. A method comprising:
monitoring access to a central marketplace platform of an online marketplace, by user devices located in a region that corresponds to a remote marketplace platform of the online marketplace, for content not available at the remote marketplace platform;
determining a set of popular content attributes for the remote marketplace platform based on the access to the central marketplace, by the user devices located in the region, for the content not available at the remote marketplace platform, the set of popular content attributes including one or more content attributes determined to be of interest in the region based on the access, by the user devices located in the region, to the central marketplace for the content not available at the remote marketplace platform;
identifying, based on the set of popular content attributes, one or more categories of the content at the central marketplace platform that match one or more content attributes of the set of popular content attributes;
sending, as matching content, the content that corresponds to the one or more categories, to the remote marketplace platform, for storage at the remote marketplace platform; and
in response to receiving a user request related to the matching content and that originated from a user device located in the region, retrieving, for access by the user device, the matching content from the remote marketplace platform instead of the central marketplace platform to reduce a load time of the matching content on the user device.

7. A method as claimed in claim 6, further comprising:
analyzing new content at the central marketplace platform using the set of popular content attributes to identify one or more categories of the new content that match one or more content attributes of the set of popular content attributes, the new content being received at the central marketplace platform after sending the matching content to remote marketplace platform; and
sending, as matching new content, the new content that corresponds to the one or more categories, to the remote marketplace platform, for storage at the remote marketplace platform.

8. A method as claimed in claim 6, further comprising:
updating the set of popular content attributes based on changes to content accessed on the central marketplace platform by the user devices located in the region, as indicated by the monitoring of the access to the central marketplace platform;
identifying, based on the updated set of popular content attributes, one or more additional categories of the content at the central marketplace platform that match one or more additional content attributes of the updated set of popular content attributes; and
sending, as new matching content, content that corresponds to the one or more additional categories, to the remote marketplace platform, for storage at the remote marketplace platform.

9. A method as claimed in claim 6, further comprising:
determining a threshold score that is calculated based on the access to the central marketplace platform by the user devices located in the region;
determining a content score for the one or more categories of the content based on the set of popular content attributes;
comparing the threshold score with the content score; and
identifying the one or more categories of the content that match the one or more content attributes of the set of popular content attributes based on the one or more categories having a content score higher than the threshold score.

10. A method as claimed in claim 6, wherein the user transactions comprise one or more transactions selected from a group of transactions consisting of: searching content for goods of potential interest to the user; reviewing results of the content searches; making inquiries to one or more sellers of the goods; bidding on one or more of the goods; and purchasing one or more of the goods.

11. A system comprising:
a first apparatus storing content for a central marketplace platform of an online marketplace;
a second apparatus storing content for a remote marketplace platform of the online marketplace; and
at least one processor configured to cause the performance of operations, the operations comprising:
track one or more content attributes of goods listed on the online marketplace;
monitor remote user transactions on the online marketplace with respect to the goods in which the remote user transactions are performed on user devices located in a region that corresponds to the remote marketplace platform;
determine a set of popular content attributes for the remote marketplace platform, the set of popular content attributes including one or more of the tracked content attributes determined to be of interest in the region based on the monitoring of the remote user transactions;
analyze the content related to goods listed on the online marketplace and that is stored at the central marketplace platform;
identify, as matching content and based on the analyzing of the content, which of the content stored at the central marketplace platform has attributes that sufficiently match one or more content attributes included in the set of popular content attributes;
send, based on the matching content having attributes that sufficiently match the one or more popular content attributes, the matching content from the first apparatus to the remote marketplace platform for storage at the second apparatus; and
in response to receiving a user request related to the matching content and that originated from a user device located in the region, retrieve, for access by the user device, the matching content from the remote marketplace platform instead of the central marketplace platform to reduce a load time of the matching content on the user device.

12. A system as claimed in claim 11, wherein the operations further comprise:
analyze new content at the central marketplace platform using the popular content attributes, the new content being received at the central marketplace platform after sending the matching content to remote marketplace platform;
identify, as matching new content and based on the analyzing of the new content, which of the new content stored at the central marketplace platform has attributes that sufficiently match one or more popular content attributes included in the set of popular content attributes;
send, based on the matching new content having attributes that sufficiently match the one or more popular content attributes, the matching new content from the central marketplace platform to the remote marketplace platform for storage at the remote marketplace platform; and
in response to receiving a user request related to the matching new content and that originated from the user device located in the region, retrieve the matching new content from the remote marketplace platform instead of the central marketplace platform to reduce a load time of the matching new content on the user device.

13. A system as claimed in claim 11, wherein the operations further comprise:
update the set of popular content attributes in response to changes to the goods listed on the online marketplace and an update to the one or more popularity attributes; and
identify the matching content based on the updated set of popular content attributes.

14. A system as claimed in claim 11, wherein the operations further comprise:
determine a threshold score for one or more of the popular content attributes;
determine a content score for the content at the central marketplace platform using the popular content attributes; and
compare the threshold score with the content score in which content having a score higher than the threshold score is identified as the matching content.

15. A system as claimed in claim 11, wherein the user transactions comprise one or more transactions selected from a group of transactions consisting of: searching content for goods of potential interest to the user;
reviewing results of the content searches; making inquiries to one or more sellers of the goods;
bidding on one or more of the goods; and purchasing one or more of the goods.

16. A system comprising:
a first apparatus storing content for a central marketplace platform of an online marketplace;
a second apparatus storing content for a remote marketplace platform of the online marketplace; and
at least one processor configured to cause the performance of, the operations comprising:
monitor access to the central marketplace platform by user devices located in a region that corresponds to the remote marketplace platform, for content not available at the remote marketplace platform;
determine a set of popular content attributes for the remote marketplace platform based on the access to the central marketplace, by the user devices located in the region, for the content not available at the remote marketplace platform, the set of popular content attributes including one or more content attributes determined to be of interest in the region based on the access, by the user devices located in the region, to the central marketplace for the content not available at the remote marketplace platform;
identify, based on the set of popular content attributes, one or more categories of the content at the central marketplace platform that match one or more content attributes of the set of popular content attributes;
send, as matching content, the content that corresponds to the one or more categories, from the first apparatus to the remote marketplace platform, for storage at the second apparatus; and
in response to receiving a user request related to the matching content and that originated from a user device located in the region, retrieve, for access by the user device, the matching content from the remote marketplace platform instead of the central marketplace platform to reduce a load time of the matching content on the user device.

17. A system as claimed in claim 16, wherein the operations further comprise:
analyze new content at the central marketplace platform using the set of popular content attributes to identify one or more categories of the new content that match one or more content attributes of the set of popular content attributes, the new content being received at the central marketplace platform after sending the matching content to remote marketplace platform; and
send, as matching new content, the new content that corresponds to the one or more categories, to the remote marketplace platform, for storage at the remote marketplace platform.

18. A system as claimed in claim 16, wherein the operations further comprise:
update the set of popular content attributes based on changes to content accessed on the central marketplace platform by the user devices located in the region, as indicated by the monitoring of the access to the central marketplace platform;
identify, based on the updated set of popular content attributes, one or more additional categories of the content at the central marketplace platform that match one or more additional content attributes of the updated set of popular content attributes; and
send, as new matching content, content that corresponds to the one or more additional categories, to the remote marketplace platform, for storage at the remote marketplace platform.

19. A system as claimed in claim 16, wherein the operations further comprise:
determine a threshold score that is calculated based on the access to the central marketplace platform by the user devices located in the region;
determine a content score for the one or more categories of the content based on the set of popular content attributes;
compare the threshold score with the content score; and
identify the one or more categories of the content that match the one or more content attributes of the set of popular content attributes based on the one or more categories having a content score higher than the threshold score.

20. A system as claimed in claim 16, wherein the user transactions comprise one or more transactions selected from a group of transactions consisting of: searching content for goods of potential interest to the user;
reviewing results of the content searches; making inquiries to one or more sellers of the goods;
bidding on one or more of the goods; and purchasing one or more of the goods.
